(19) United States
(12) Patent Application Publication
(10) Pub. No.: US 2008/0046255 A1
(43) Pub. Date: Feb. 21, 2008

(54) Tradeshow handouts valet and shipping system

(75) Inventor: William N. Stelcher, Sarasota, FL (US)

Correspondence Address: SCHIFF HARDIN, LLP;PATENT DEPARTMENT, 6600 SEARS TOWER, CHICAGO, IL, 60606-6473, US

(73) Assignee: Stelcher Enterprises

(21) Appl. No.: 11/418,655

(22) Filed: May 5, 2006

(51) Int. Cl. G06Q 10/00; G06Q 30/00

(52) U.S. Cl. 705/1

(57) ABSTRACT

In a method for collecting and transporting handouts at a tradeshow, a handouts valet and shipping system provider location is established. A plurality of handouts valet carts and customer ship-back cartons are provided at the location. When visiting the provider location, a tradeshow attendee obtains one of the handouts valet carts together with the ship-back carton from the provider, and provides a mailing address to the provider for the ship-back of the carton. The carton is placed on the cart. The tradeshow attendee thus becomes a customer of the provider for the cart with the ship-back carton thereon. When the customer is ready to leave the tradeshow, the customer drops off the carton at the system provider location, and the system provider mails the carton with the handouts to the customer's mailing address.

### BACKGROUND

At tradeshows, exhibitors at exhibitor booths typically provide handouts such as literature, information, samples, etc. when customers visit the exhibitor booths. It was previously known to provide flexible plastic bags to tradeshow attendees for collecting the handouts from the exhibitors.

As the tradeshow attendee collects more and more handouts, the bag becomes heavier and more cumbersome. Tradeshow attendees may thus become more selective either at the beginning or during their meanderings about the tradeshow exhibit area to limit the inconvenience of having a bag which becomes awkward to carry, both during the tradeshow and during the journey home, which may likely include air travel.

### SUMMARY

It is an object to provide a system which improves upon collection of handouts at a tradeshow and transporting those handouts to a desired location such as an office or home.

In a method for collecting and transporting handouts at a tradeshow, a handouts valet and shipping system provider location is established. A plurality of handouts valet carts and customer ship-back cartons are provided at the location. When visiting the provider location, a tradeshow attendee obtains one of the handouts valet carts together with the ship-back carton from the provider, and provides a mailing address to the provider for the ship-back of the carton. The carton is placed on the cart. The tradeshow attendee thus becomes a customer of the provider for the cart with the ship-back carton thereon. When the customer is ready to leave the tradeshow, the customer drops off the carton at the system provider location, and the system provider mails the carton with the handouts to the customer's mailing address.

### BRIEF DESCRIPTION OF THE DRAWINGS

FIG. 1 is a perspective view of a tradeshow and illustrating the tradeshow handouts valet and shipping system of the preferred embodiment;

FIG. 2 is a rental and shipping flow chart for the tradeshow handouts valet and shipping system;

FIG. 3 is a purchase and shipping flow chart for the tradeshow handouts valet and shipping system; and

FIG. 4 is a purchase flow chart for the tradeshow handouts valet and shipping system.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

At the outset, it is noted that the term “tradeshow” includes shows, conferences, meetings, etc. where exhibitors or the like provide handouts. The handouts may include, for example, literature, samples, various types of information media, etc. Also, the word “booth” refers generally to a particular area, and may comprise a table, a shelf, etc. of an exhibitor, tradeshow registrar, or system provider.

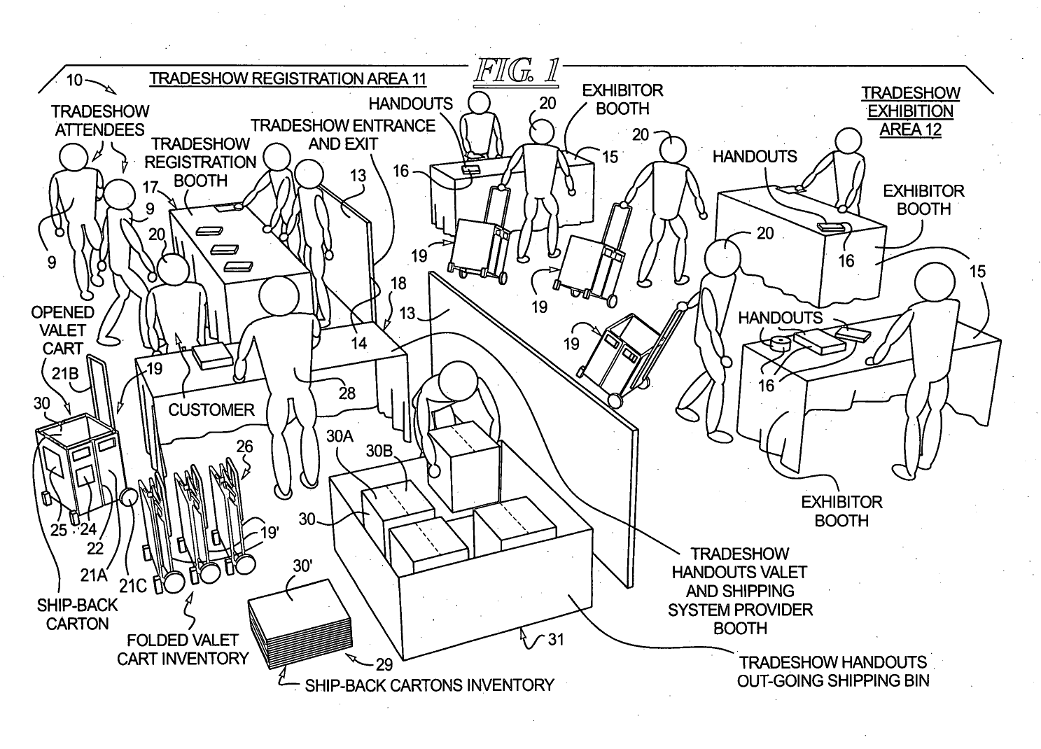

The tradeshow handouts valet and shipping system method is shown in one preferred embodiment at a tradeshow generally illustrated at 10 in FIG. 1. The tradeshow 10 typically encompasses a tradeshow registration area 11 and a tradeshow exhibition area 12. Tradeshow attendees 9 entering the tradeshow typically register at a tradeshow registration booth 17. They then enter the tradeshow exhibition area 12 through the tradeshow entrance and exit 14 typically created by an opening in a divider curtain, wall, or other type of separation 13. Once in the exhibition area 12, the tradeshow attendees 9 visit a plurality of exhibitor booths 15, one or more of which have handouts 16. The handouts may comprise a wide variety of articles such as literature, discs, samples, etc.

In the tradeshow registration area 11, a tradeshow valet system provider booth 18 is provided, preferably near the tradeshow registration booth 17. The tradeshow valet system provider booth 18 has one or more system provider representatives 28 manning the booth. It should be understood, of course, that the system provider booth may be a part of the registration booth or may not be a booth at all, but merely a location, preferably in the tradeshow registration area 11. It is also possible, of course that the system provider booth or location may also be located within the tradeshow exhibition area 12 or other location within proximity to the tradeshow.

When a tradeshow attendee 9 registers at the registration booth 17, he or she may notice the tradeshow valet system provider booth 18 located near the registration booth 17.

The tradeshow valet system provider booth has an inventory of valet carts such as shown at 19 in an opened configuration. These valet carts may be collapsed such as by folding at hinged sides as shown at 26 illustrating a plurality of collapsed carts 19′. Additionally, ship-back cartons 30 which are preferably foldable cardboard, are provided as an inventory 29 shown collapsed at 30′. The carton also preferably has closing flaps 30A, 30B. If one or more of the tradeshow attendees 9 becomes a customer 20 for a handouts valet cart, he or she is given at least one of the open valet carts 19 along with an opened ship-back carton 30 which is inserted into the open valet cart 19 with the flaps 30A, B folded open and outside the sidewalls of the carton 30.

The valet cart 19 may, for example, be a folding cart obtained for example, from the Jiangsu Holly Corporation in China or other cart provider. Such a cart has an open box-like container 21A with an attached handle 21B. The handle may be telescopically collapsible. The container 21A itself is collapsible by folding along hinge lines 22, for example. The cart 19 also has wheels 21C.

Advertising placards or indicia, such as shown at 24 or 25, may be attached to the sides or front of the container 21A.

The customer 20 rents or buys the valet cart 19 from the representative 28 at the tradeshow handouts valet and shipping system provider booth 18. The customer 20 then enters the tradeshow through the entrance 14 and places handouts 16 from one or more of the exhibitor booths 15 into the container 21 A of the opened cart 19.

When the customer is finished touring the exhibition area 12 of the tradeshow, he or she then exits at the exit 14 and may return to the valet cart system provider booth 18 to return the cart if he or she had rented or purchased it there.

After closing and sealing the closing flaps 30A, B, the carton 23 containing the handouts is handed to the representative 28. The box is at some point brought to a tradeshow handouts outgoing shipping bin 31. From there the cartons are shipped to the customer.

If the customer purchased the cart 19, he or she may then simply give the representative 28 the carton with the handouts for mailing to the customer at the customer's office or home, for example. The customer would then leave with the cart.

It is also envisioned that a customer, who rented rather than purchased the cart, may still leave with the cart without returning it to the provider booth 18.

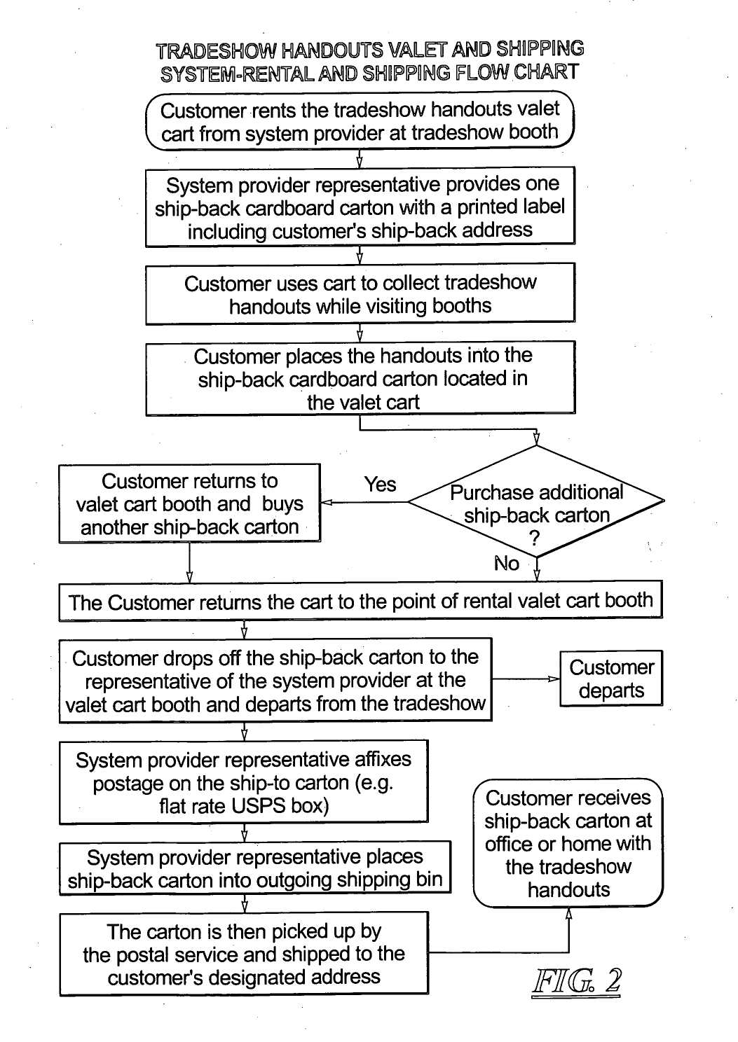

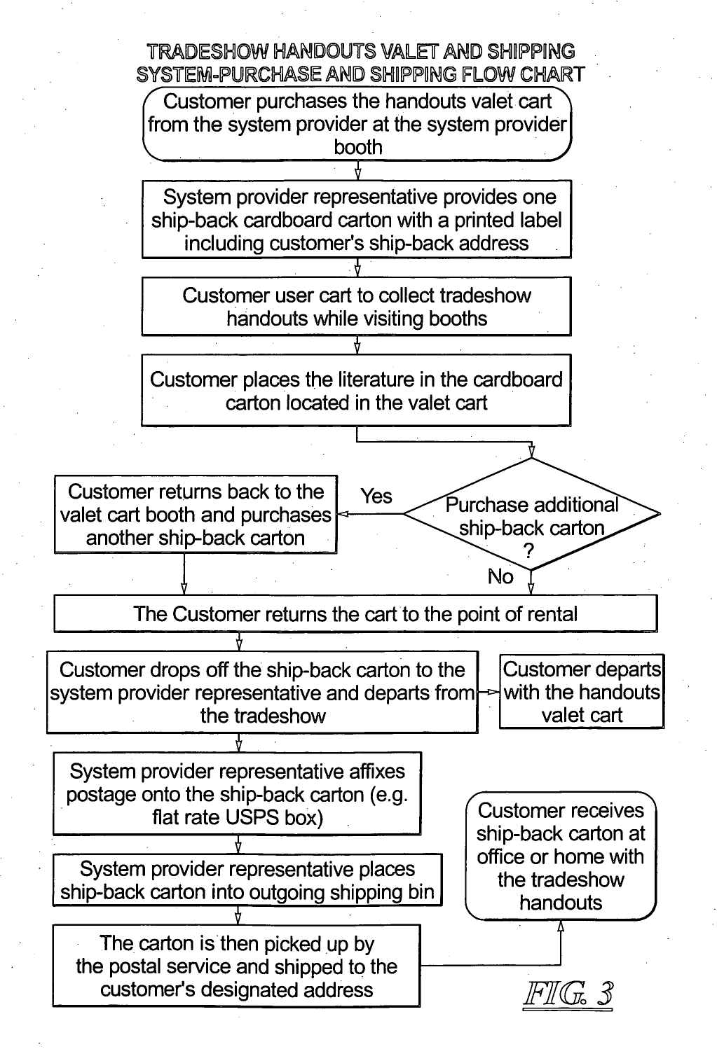

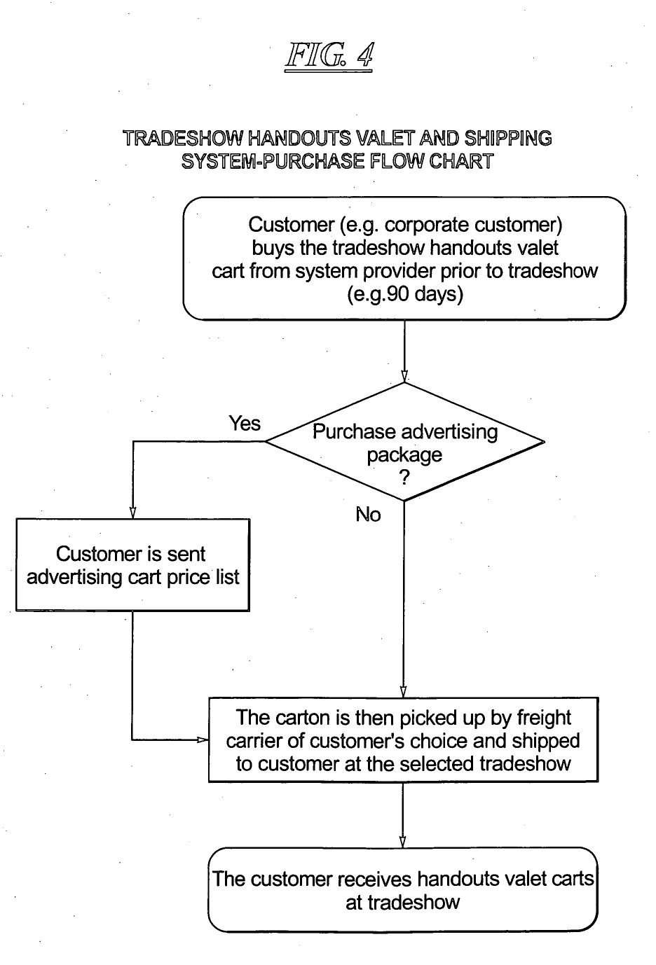

Further details and alternatives of the system are set forth in the various flow chart steps of FIGS. 2, 3, and 4. Because those flow charts are detailed explanations in themselves, the text present in FIGS. 2, 3, and 4 will not be repeated here. However, the following additional descriptions are provided.

### Renting the Cart

When utilizing the rental option, the customer may rent the cart, for example as a one-day cart usage where the rental fee also includes the ship-back mailing carton and shipping to the customer. With this option, the following method steps occur with the following options and variations:
1. The customer rents the valet cart from the system provider such as at the designated booth.
2. The valet system provider representative provides one ship-back cardboard carton with a printed label including customer's ship-back address.
3. The customer uses the cart to collect handouts such as literature, information, cds, etc. while visiting booths or stands.
4. The customer inserts the literature in the ship-back carton located in the valet cart (additional cartons can be purchased.)
5. When leaving the customer returns to the rental booth.
6. The customer then returns the cart and presents the ship-back carton to the valet system provider representative and departs from the show, conference or meeting.
7. The valet system representative places postage onto the ship-back carton (e.g.—flat rate postal box) and puts it into an outgoing shipping bin.
8. The carton is then picked up by the postal service and shipped to the customer's designated address.

If the customer returns to the tradeshow, meeting or conference for a second day, the customer can present the receipt from the earlier day and receive a free rental of the valet cart for a second day. The customer may then purchase an additional ship-back carton for any new materials collected.

Space on the valet cart may be used as a source of advertising revenue to be sold by the system provider or the governing tradeshow association.

### Purchasing the Cart

With this option, the following steps may be provided:
1. The customer purchases the valet cart from the system provider such as at the designated booth.
2. The valet system representative provides one ship-back cardboard carton with a printed label which reflects the customer's ship-back address.
3. The customer uses the cart to collect handouts such as literature, information, cds, etc. while visiting booths or stands.
4. The customer inserts the handouts in the cardboard carton located in the valet cart (additional cartons can be purchased.)
5. The customer returns to the point of purchase system provider booth.
6. The customer then hands the ship-back carton to the valet system representative and departs from the show, conference or meeting with their new valet cart.
7. The valet system representative places postage onto the ship-back carton (e.g.—flat rate *postal service box) and puts it into outgoing shipping bin.
8. The carton is then picked up by the postal service and shipped to the customer's designated address.

The system provider or the governing tradeshow association may sell advertising space on the sides of the valet cart as a source of revenue. Promotion to encourage the use of the valet system may be considered part of the governing tradeshow's obligations.

If the customer returns to the tradeshow, meeting or conference for a second day, he or she may present his or her receipt at the original point of purchase from the earlier day and then buy additional cardboard cartons for new materials collected which will be shipped to his or her address as above. At any tradeshow the customer attends with the valet cart, and provided the valet system is in place, the customer will be given the opportunity to use the valet shipping service. Whether one time or many times, the customer only shows the valet cart and the provider will sell them one of the ship-back cartons.

### Purchasing the Cart without the Shipping Service

It is also envisioned that a customer may purchase a quantity of carts without purchasing the shipping service. In this event, the following steps would apply where that customer may be an individual, or any company, organization, association or group exhibiting at a tradeshow, conference or meeting:
1. The customer purchases a quantity of the tradeshow handout valet carts with or without ship-back boxes from the system provider or designated agent. The price of these carts depends on the quantity purchased. Carts with or without boxes are delivered to the customer's tradeshow booth prior to the opening of the tradeshow.
2. Color graphics are affixed to the cart panel or panels promoting the customer, his booth number and/or product. The cost of the graphics is not included in the cost of the carts.
3. When an attendee visits the customer's booth or stand he may give away one or more carts or offer the cart or carts as an incentive for visiting his booth or stand.
4. The attendee uses the handouts valet cart to collect materials and information and takes the cart with him when he leaves the event.

The system provider or the governing tradeshow association may sell the cart and advertising space on the sides of the valet cart as a source of revenue. Promotion to encourage the use of the valet cart system may be considered part of the governing tradeshow's obligations.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A method for collecting and transporting handouts at a tradeshow, comprising the steps of:
establishing at the tradeshow a handouts valet and shipping system provider location, and at said location providing a plurality of handouts valet carts and customer ship-back cartons;
when visiting the system provider location a tradeshow attendee obtaining one of the handouts valet carts together with a carton from the provider, and provides a mailing address to the provider for the ship-back of the carton, the carton being placed on the cart, and said tradeshow attendee thus becoming a customer of the provider for said cart with said carton thereon;
said customer pulling the cart and circulating in an exhibition area of the tradeshow, and said customer collecting and placing exhibitor handouts into said ship-back carton on said cart;
when said customer is ready to leave the tradeshow, the customer dropping off the carton at said system provider location; and
said system provider mailing the carton with the collected handouts to said mailing address of the customer.

2. A method of claim 1 wherein the system provider location is located outside the tradeshow exhibition area in a registration area of the tradeshow.

3. A method of claim 1 wherein the cart is collapsible.

4. A method of claim 1 wherein said 1 ship-back carton comprises cardboard and is foldable.

5. A method of claim 1 wherein said carton has closing flaps which are folded back along sides of the carton when placed in a container of the cart.

6. A method of claim 1 wherein said customer rents the valet cart from the system provider and returns the rented cart to the system provider at said location when the customer is leaving the tradeshow.

7. A method of claim 1 wherein said customer purchases the valet cart from the system provider and keeps the cart when the customer leaves the tradeshow.

8. A method of claim 1 wherein said handouts comprise at least one of the elements selected from a group consisting of literature, information, and samples.

9. A method of claim 1 wherein advertising is placed on at least one side of a box-like container of the cart.

10. A method of claim 1 wherein the cart has a telescopic retractable handle.

11. A method of claim 1 wherein the cart has a box-like container with an open top and said ship-back carton is received in said container.

12. A method of claim 11 wherein said box-like container is collapsible.

13. A method of claim 12 wherein said box-like container is collapsed by folding at hinged sides of the container.

14. A method of claim 1 wherein at the provider location a plurality of said valet carts in a collapsed configuration and a plurality of said ship-back cartons in a collapsed configuration are provided.

15. A method of claim 1 wherein the provider seals and places the returned ship-back cartons with collected handouts therein in a shipping bin.

16. A method of claim 15 wherein the shipping bin is located at the tradeshow near the provider location.

17. A method of claim 1 wherein a customer may purchase said cart from said system provider without a ship-back carton without purchasing ship-back of the carton.

18. A method of claim 17 wherein the customer purchases a plurality of said carts.

19. A method for collecting and transporting handouts at a tradeshow, comprising the steps of:
establishing at the tradeshow a handouts valet and shipping system provider location, and at said location providing a plurality of handouts valet cart and customer containers;
when visiting the system provider location a tradeshow attendee renting one of the handouts valet carts together with a container from the provider, the container being placed on the cart, and said tradeshow attendee thus becoming a customer of the provider for said cart with said container thereon;
said customer pulling the cart and circulating in an exhibition area of the tradeshow, and said customer collecting and placing exhibitor handouts into said container on said cart; and
when said customer is ready to leave the tradeshow, the customer returning the cart at said system provider location.

20. A method for collecting and transporting handouts at a tradeshow, comprising the steps of:
establishing at the tradeshow a handouts valet and shipping system provider location, and at said location providing a plurality of handouts valet cart and customer ship-back cartons;
when visiting the system provider location a tradeshow attendee renting one of the handouts valet carts together with a carton from the provider, and provides a mailing address to the provider for the ship-back of the carton, the carton being placed in a container of the cart, and said tradeshow attendee thus becoming a customer of the provider for said cart with said carton;
said customer pulling the cart and circulating in an exhibition area of the tradeshow, and said customer collecting and placing exhibitor handouts into said ship-back carton on said cart;
when said customer is ready to leave the tradeshow, the customer dropping off the carton at said system provider location; and
said system provider mailing the carton with the collected handouts to said mailing address of the customer.

21. A method of claim 20 wherein the carton comprises a collapsible cardboard carton.

22. A method of claim 20 wherein the cart has hinged sides and is collapsible.
